(19) United States
(12) Patent Application Publication
(10) Pub. No.: US 2014/0183209 A1
(43) Pub. Date: Jul. 3, 2014

(54) AUTOMATIC VENDING MACHINE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: ZHI-YONG GAO, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/053,827

(22) Filed: Oct. 15, 2013

(30) Foreign Application Priority Data
Jan. 3, 2013 (CN) 2013100003113

(51) Int. Cl. G07F 11/54; G07F 11/62

(52) U.S. Cl. CPC G07F 11/54; G07F 11/62
USPC 221/122

(57) ABSTRACT

An automatic vending machine includes a cabinet and a dispensing mechanism. The cabinet includes a top plate, two side plates, and a blocking plate. The two side plates are located on the top plate, and the blocking plate is located between the two side plates and parallel to the top plate and defines an opening. The dispensing mechanism is hanging on the top plate and comprises placing passages configured to receive products. One of the placing passages is staggered with the opening, and is rotatable relative to the blocking plate to align the opening, for the product to drop out of corresponding placing passage through the opening by gravity.

### BACKGROUND

1. Technical Field

The present disclosure relates to automatic vending machines, and more particularly to an automatic vending machine with a switch module.

2. Description of Related Art

An automatic vending machine always includes a plurality of passages for receiving product and a plurality of release members, such as springs. The plurality of passages is placed in a horizontal direction. Each of the plurality of release members is located on each of the plurality of passages to push product, such as tinned drinks in the horizontal direction, until the product drops out of corresponding passage. However, the process is time-consuming, and only one product may be in each passage which is very inefficient and costly. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric of an embodiment of an automatic vending machine.

FIG. 2 is an enlarged view of a circled portion II of FIG. 1.

FIG. 3 is an assembled view of the automatic vending machine of FIG. 1.

FIG. 4 is an enlarged view of a circled portion IV of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.

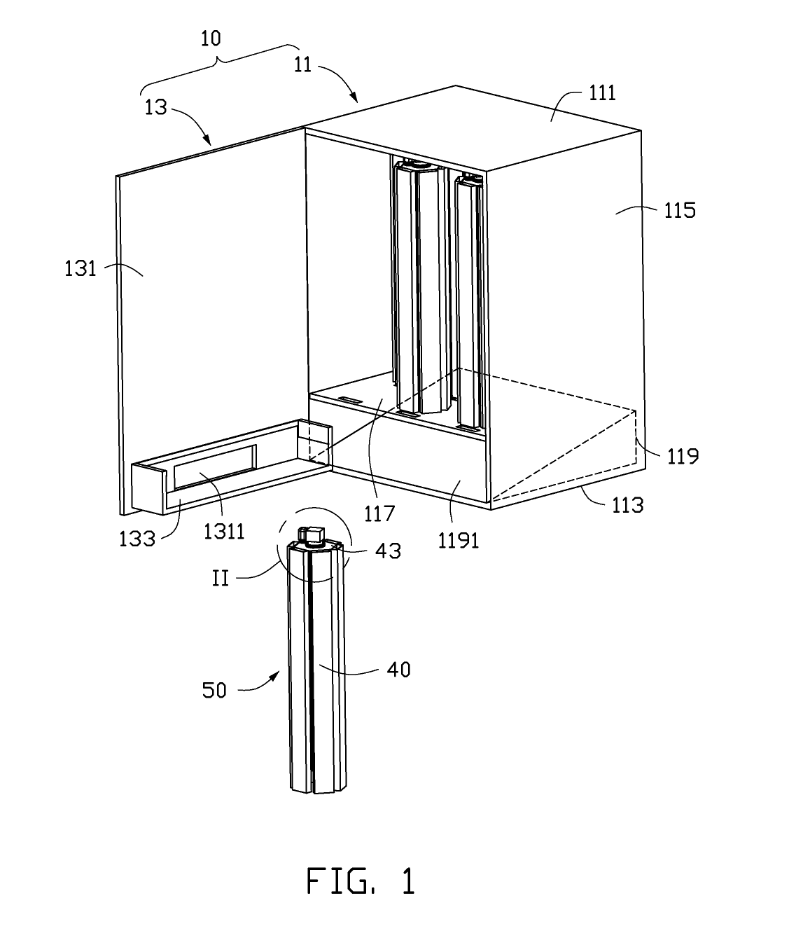

FIG. 1 illustrates an embodiment of an automatic vending machine which includes a cabinet 10 and a plurality of dispensing mechanisms 50. The plurality of dispensing mechanisms 50 are used to receive products (not shown). The products may be, for example, tinned drinks.

The cabinet 10 includes a cabinet body 11 and a front door 13 rotatably secured to the cabinet body 11. The cabinet body 11 includes a top plate 111, a bottom plate 113, and two side plates 115. The bottom plate 113 is parallel to the top plate 111. In one embodiment, the two side plates 115 are substantially parallel to each other and perpendicular to the top plate 111 and the bottom plate 113.

The cabinet 10 further includes a blocking plate 117 and a buffering block 119. The blocking plate 117 is installed between the two side plates 115 and defines an opening 1171 corresponding to each of the plurality of dispensing mechanisms 50. In this embodiment, the blocking plate 117 is substantially perpendicular to the two side plates 115 and parallel to the bottom plate 113 and the top plate 111. The buffering block 119 is located on the bottom plate 113 and includes a buffering surface 1191. An acute angle is defined between the bottom plate 113 and the buffering surface 1191, and acute angle is defined between the buffering surface 1191 and the blocking plate 117. The buffering surface 1191 is slanted towards the front door 13 so that the product can slid on the buffering surface 1191.

One side of the front door 11 is rotatably secured to one of the two side plates 115 for covering the cabinet body 11. The front door 13 includes a front plate 131 and a receiving tray 133 located on the front plate 131. The front plate 131 covers the cabinet body 11 and defines an exit 1311 extending to the receiving tray 133 for taking product away from the cabinet 10 through the exit 1311. The receiving tray 133 receives product sliding from the buffering block 119.

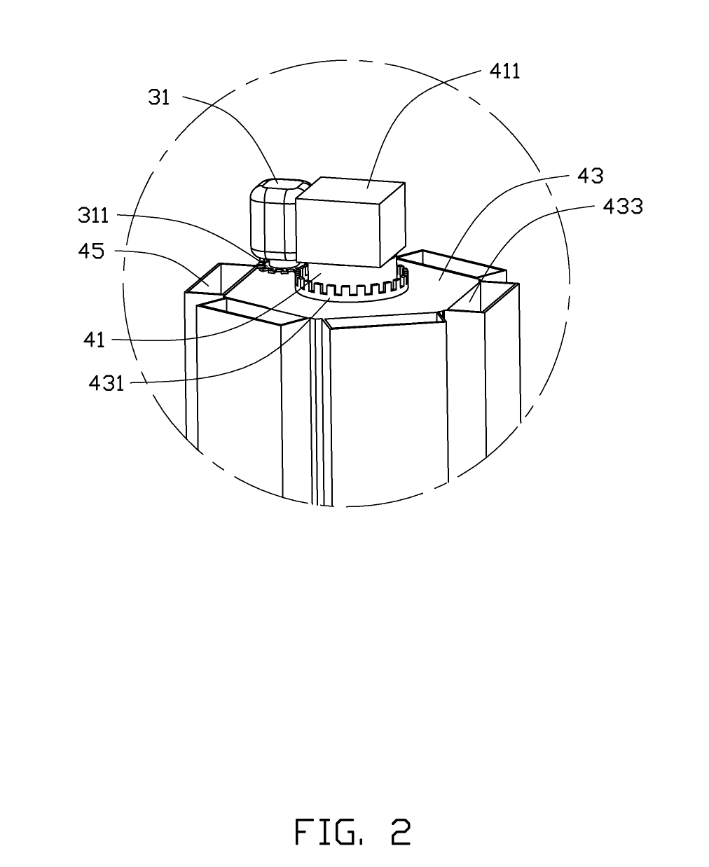

FIGS. 1-2 show that each dispensing mechanism 50 includes a motor 31 and a dispensing cabinet body 40. A drive gear 311 is connected to the motor 31. The dispensing cabinet body 40 includes a positioning shaft 41, a rotating shaft 43, and a plurality of placing passages 45 for storage products. A mounting portion 411 is located on a top end of the positioning shaft 41. The mounting portion 411 is secured to the top plate 111 by well know ways, such as soldering or screws so that the dispensing cabinet body 40 is hanging on the top plate 111. A slave gear 431 is located on the rotating shaft 43 and adjacent to the mounting portion 411. The drive gear 311 is meshed with the slave gear 431 so that the slave gear 431 is rotated by the drive gear 311 when the motor 31 rotates the drive gear 311. The rotating shaft 43 is rotatable with the slave gear 431 and includes a plurality of sidewalls 433 corresponding to the plurality of placing passages 45. Each of the plurality of placing passages 45 is secured to each of the plurality of sidewalls 433 in vertical direction so that the product can drop out of corresponding placing passage 45 by gravity. In one embodiment, the rotating shaft 43 has a hexagonal cross-section, and the plurality of placing passages 45 are symmetry about a center axis of the rotating shaft 43.

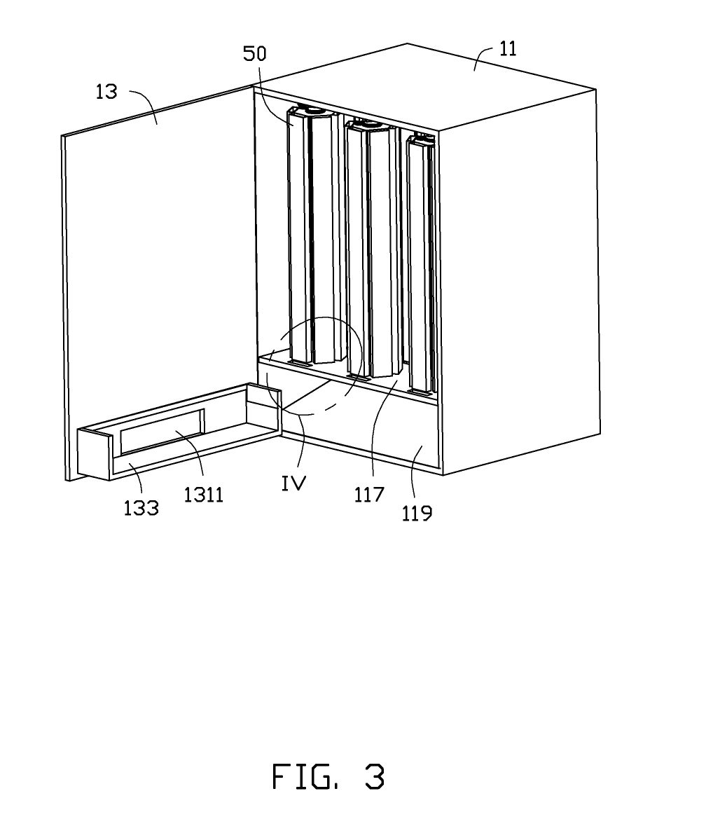

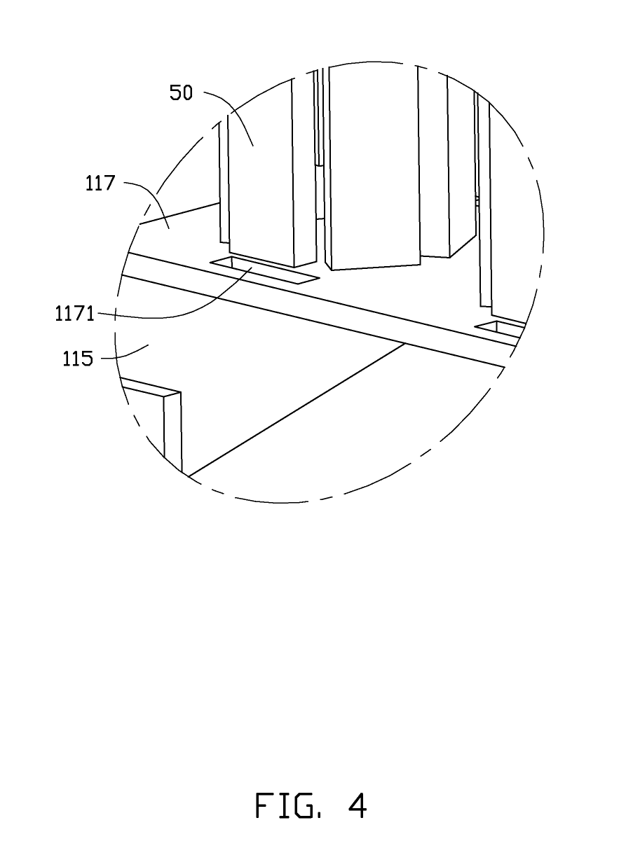

FIG. 3-4 show that in assembly, the motor 31 is secured to the mounting portion 411, and the drive gear 311 is meshed with the slave gear 431. The mounting portion 411 is secured to the top plate 111 to secure corresponding dispensing mechanism 50 to the cabinet 10. The plurality of placing passages 45 is rotatable relative to the blocking plate 117 between a first position and a second position. When the plurality of placing passages 45 are located on the first position, one of the plurality of placing passages 45 is staggered with the opening 1171, for preventing product from dropping out of corresponding placing passage 45 through the opening 1171. When the plurality of placing passages 45 are located on the second position, the one of the plurality of placing passages 45 is aligned with the opening 1171, and the product can drop out of corresponding placing passage 45 through the opening 1171. In this embodiment, each of the plurality of placing passages 45 has an extension direction that is parallel to the center axis and the top plate 111.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic vending machine comprising:
a cabinet comprising a top plate, two side plates, and a blocking plate; the two side plates being located on the top plate, and the blocking plate being located between the two side plates and parallel to the top plate, an opening being defined in the blocking plate; and
a dispensing mechanism hang on the top plate and comprising a plurality of placing passages configured to receive plurality of products,
wherein the dispensing mechanism is rotatable relative to the blocking plate between a first position and a second position; when the plurality of placing passages is located on the first position, one of the plurality of placing passages is staggered with the opening, for preventing the product from dropping out of corresponding placing passage through the opening; and when the one of the plurality of placing passages is aligned with the opening, and the product is configured to drop out of corresponding placing passage.

2. The automatic vending machine of claim 1, wherein the dispensing mechanism further comprises a rotating shaft, the plurality of placing passages is located on the rotating shaft, and the plurality of placing passages is rotatable with the rotating shaft.

3. The automatic vending machine of claim 2, wherein the dispensing mechanism further comprises a positioning shaft, the rotating shaft is rotatably secured to the positioning shaft; and the positioning shaft is installed on the top plate.

4. The automatic vending machine of claim 3, wherein a mounting portion is located on the positioning shaft, and the mounting portion is secured to the top plate.

5. The automatic vending machine of claim 2, wherein the dispensing mechanism further comprises a drive gear, a slave gear is located on the rotating shaft, and the drive gear is meshed with the slave gear to rotate the slave gear.

6. The automatic vending machine of claim 5, wherein the dispensing mechanism further comprises a motor, the drive gear is located on the motor, and the motor rotates the drive gear.

7. The automatic vending machine of claim 2, wherein the plurality of placing passages is symmetry about a center axis of the rotating shaft.

8. The automatic vending machine of claim 7, wherein each of the plurality of placing passages having an extension direction that perpendicular to the blocking plate and parallel to the center axis of the rotating shaft.

9. The automatic vending machine of claim 2, wherein the rotating shaft has a hexagonal cross-section.

10. The automatic vending machine of claim 1, wherein the cabinet further comprises a bottom plate parallel to the top plate and a buffering block, the buffering block is located on the bottom plate and has a buffering surface, an acute angle is defined between the buffering surface and the bottom plate, and an acute angle is defined between the buffering surface and the blocking plate.

11. An automatic vending machine comprising:
a cabinet comprising a cabinet body and a blocking plate located on the cabinet body; an opening defined in the blocking plate; and
a dispensing mechanism being hang on cabinet body and comprising a plurality of placing passages configured to receive plurality of products,
wherein one of the plurality of placing passages is staggered with the opening, and the plurality of placing passages is rotatable relative to the blocking plate to align the one of the plurality of placing passages with the opening.

12. The automatic vending machine of claim 11, wherein the cabinet body comprises a top plate and two side plates located on the top plate, the dispensing mechanism is hang on the top plate, and the blocking plate is located between the two side plates.

13. The automatic vending machine of claim 12, wherein the dispensing mechanism further comprises a rotating shaft, the plurality of placing passages is located on the rotating shaft, and the plurality of placing passages is rotatable with the rotating shaft.

14. The automatic vending machine of claim 13, wherein the dispensing mechanism further comprises a positioning shaft, the rotating shaft is rotatably secured to the positioning shaft; and the positioning shaft is installed on the top plate.

15. The automatic vending machine of claim 14, wherein a mounting portion is located on the positioning shaft, and the mounting portion is secured to the top plate.

16. The automatic vending machine of claim 13, wherein the dispensing mechanism further comprises a drive gear, a slave gear is located on the rotating shaft, and the drive gear is meshed with the slave gear to rotate the slave gear.

17. The automatic vending machine of claim 16, wherein the dispensing mechanism further comprises a motor, the drive gear is located on the motor, and the motor rotates the drive gear.

18. The automatic vending machine of claim 13, wherein the plurality of placing passages is symmetry about an center axis of the rotating shaft.

19. The automatic vending machine of claim 18, wherein each of the plurality of placing passages having an extension direction that perpendicular to the blocking plate and parallel to the center axis of the rotating shaft.

20. The automatic vending machine of claim 12, wherein the rotating shaft has a hexagonal cross-section.
